(19) United States
(12) Patent Application Publication
(10) Pub. No.: US 2013/0247352 A1
(43) Pub. Date: Sep. 26, 2013

(54) Method for Designing Indoor Lighting

(71) Applicant: TOSHIBA LIGHTING & TECHNOLOGY CORPORATION, Yokosuka-shi (JP)

(72) Inventors: Yoko Noguchi, Yokosuka-shi (JP); Tomoko Ishiwata, Yokosuka-shi (JP); Kazunori Yashiro, Yokosuka-shi (JP); Masaru Inoue, Yokosuka-shi (JP); Makoto Kawagoe, Yokosuka-shi (JP); Hitoshi Kawano, Yokosuka-shi (JP); Shigehisa Kawatsuru, Yokosuka-shi (JP); Fumie Iwata, Yokosuka-shi (JP)

(73) Assignee: TOSHIBA LIGHTING & TECHNOLOGY CORPORATION, Yokosuka-shi (JP)

(21) Appl. No.: 13/828,235

(22) Filed: Mar. 14, 2013

(30) Foreign Application Priority Data
Mar. 26, 2012 (JP) 2012-070082

(51) Int. Cl. F21V 19/00

(52) U.S. Cl. CPC F21V 19/00
USPC 29/428

(57) ABSTRACT

A method for designing indoor lighting includes disposing a first luminaire on a ceiling surface that forms an indoor space, the first luminaire having a luminous intensity distribution characteristic that a luminous flux over a range of luminous intensity distribution angles no smaller than 90 degrees but no greater than 120 degrees with respect to a vertically downward direction, which represents 0 degrees, is 20% of a luminous flux of the luminaire or greater and a luminous flux over a range of luminous intensity distribution angles no smaller than 60 degrees but smaller than 90 degrees is 20% of the luminous flux of the luminaire or smaller; and disposing a second luminaire in the indoor space, the second luminaire illuminating a wall surface present in a region corresponding to the luminous intensity distribution angles of light from the first luminaire no less than 60 degrees but smaller than 90 degrees.

### CROSS-REFERENCE TO RELATED APPLICATION

This application is based upon and claims the benefit of priority from Japanese Patent Application No 2012-70082 filed Mar. 26, 2012; the entire contents all of which are incorporated herein by reference.

### FIELD

Embodiments described herein relate generally to a method for designing indoor lighting.

### BACKGROUND

Lighting greatly affects comfort in an office environment and a residential environment. In designing such a lighting environment, horizontal plane illuminance is used in some cases. JIS (Japanese Industrial Standard Committee) and JISE (The Illuminating Engineering Institute of Japan) have defined illuminance standards based on horizontal plane illuminance for indoor lighting and building industries.

The horizontal plane illuminance, however, represents a luminous flux per unit area that is incident on a floor or a table but does not represent light that reaches the eyes of a person. The horizontal plane illuminance cannot therefore always be used to appropriately evaluate human's impression of a space.

In view of the fact described above, lighting design approaches based on brightness perceived by a person in the field of view of the eyes of a person who is viewing a space are considered in recent years. For example, in an indoor space, a ceiling, a wall, a floor, and other surfaces are present within the field of view of the eyes of a person, and light reflected off the surfaces described above is incident on the eyes of the person. It is therefore believed that a brightness sensation that the person has can be improved not only by increasing the illuminance at the upper surface of a table but also by illuminating the ceiling and the wall as well.

For example, http://www.tlt.co.jp/tlt/press_release/p110525/p110525.htm, which is a document about a straight tube type LED luminaire having a reverse truncated triangular shape, discloses a luminaire using a reflector having a reverse truncated triangular shape. Such a luminaire having a reverse truncated triangular shape is capable of illuminating a ceiling surface as well via the reflector, providing an advantageous effect of increasing a space brightness sensation. Further, http://www.tlt.co.jp/tlt/press_release/p111027_{—}3/p111027_{—}3.htm, which is a document about an LED thin base light, discloses a thin base light using an LED. As a thin base light, a base light having a thinnest portion as thin as 16 mm has also been developed, which can produce a space that does not cause a person to have a feeling of oppression but can give the person a feeling that a ceiling surface is part of a space.

A luminaire having a reverse truncated triangular shape, however, is formed of exposed lamps that may cause a person to feel the light from the lamps glaring. Further, a thin luminaire tends to provide a less brightness sensation than a luminaire having a reverse truncated triangular shape.

As described above, when a luminaire developed based on related art is used to increase a space brightness sensation, a glare sensation disadvantageously also increases, which prevents formation of a comfortable lighting space.

### BRIEF DESCRIPTION OF THE DRAWINGS

FIG. 1 is a descriptive diagram for describing a method for designing indoor lighting according to an exemplary embodiment;

FIG. 2 is a descriptive diagram showing a schematic cross-sectional structure of a first luminaire of two types of luminaire;

FIG. 3 is a luminous intensity distribution diagram showing the luminous intensity distribution characteristic of the luminaire shown in FIG. 2, in which the circumferential direction represents the luminous intensity distribution angle measured from the vertically downward direction, which represents zero degrees, and the radial direction represents the luminous intensity;

FIGS. 4A to 4C are descriptive diagrams for describing changes in brightness sensation provided when first and second luminaires are used;

FIG. 5 is a luminous intensity distribution diagram showing a luminous intensity distribution characteristic with the circumferential direction representing the light intensity distribution angle measured from the vertically downward direction, which represents zero degrees, and the radial direction representing the luminous intensity;

FIG. 6 is a luminous intensity distribution diagram showing a luminous intensity distribution characteristic with the circumferential direction representing the light intensity distribution angle measured from the vertically downward direction, which represents zero degrees, and the radial direction representing the luminous intensity;

FIG. 7 is a luminous intensity distribution diagram showing a luminous intensity distribution characteristic with the circumferential direction representing the light intensity distribution angle measured from the vertically downward direction, which represents zero degrees, and the radial direction representing the luminous intensity;

FIG. 8 shows graphs illustrating the relationship between a brightness sensation and working plane illuminance in a case where luminaires having the luminous intensity distribution characteristics shown in FIGS. 5 to 7 are used to illuminate a predetermined space;

FIG. 9 is a luminous intensity distribution diagram showing a luminous intensity distribution characteristic with the circumferential direction representing the light intensity distribution angle measured from the vertically downward direction, which represents zero degrees, and the radial direction representing the luminous intensity;

FIG. 10 is a luminous intensity distribution diagram showing a luminous intensity distribution characteristic with the circumferential direction representing the light intensity distribution angle measured from the vertically downward direction, which represents zero degrees, and the radial direction representing the luminous intensity;

FIG. 11 is a luminous intensity distribution diagram showing a luminous intensity distribution characteristic with the circumferential direction representing the light intensity distribution angle measured from the vertically downward direction, which represents zero degrees, and the radial direction representing the luminous intensity;

FIG. 12 shows graphs illustrating the relationship between a brightness sensation and UGR (unified glare rating) in a case where luminaires having the luminous intensity distribution characteristics shown in FIGS. 9 to 11 are used to illuminate a predetermined space; and

FIG. 13 is a descriptive diagram showing a variation.

### DETAILED DESCRIPTION

A method for designing indoor lighting according to an exemplary embodiment includes disposing a first luminaire on a ceiling surface that forms an indoor space, the first luminaire having a luminous intensity distribution characteristic so set that a luminous flux over a range of luminous intensity distribution angles greater than or equal to 90 degrees but smaller than or equal to 120 degrees with respect to a vertically downward direction, which represents 0 degrees, is 20% of a luminous flux of the luminaire or greater and a luminous flux over a range of luminous intensity distribution angles greater than or equal to 60 degrees but smaller than 90 degrees is 20% of the luminous flux of the luminaire or smaller; and disposing a second luminaire in the indoor space, the second luminaire illuminating a wall surface present in a region corresponding to the luminous intensity distribution angles of light from the first luminaire greater than or equal to 60 degrees but smaller than 90 degrees.

In the method according to the exemplary embodiment, the second luminaire may be disposed on the ceiling surface in a region between the first luminaire and the wall surface present in the region corresponding to the luminous intensity distribution angles of light from the first luminaire greater than or equal to 60 degrees but smaller than 90 degrees.

In the method according to the exemplary embodiment, the first luminaire maybe configured to have a luminous intensity distribution characteristic so set that at least 80% of a luminous flux over a range of luminous intensity distribution angles greater than or equal to 60 degrees but smaller than or equal to 180 degrees is within a range of luminous intensity distribution angles of greater than or equal to 90 degrees but smaller than 110 degrees.

In the method according to the exemplary embodiment, the first and second luminaires maybe so disposed that illuminance uniformity on a wall surface illuminated by the first and second luminaires is greater than the illuminance uniformity on the wall surface illuminated by one of the first and second luminaires.

An exemplary embodiment will be described below in detail with reference to the drawings.

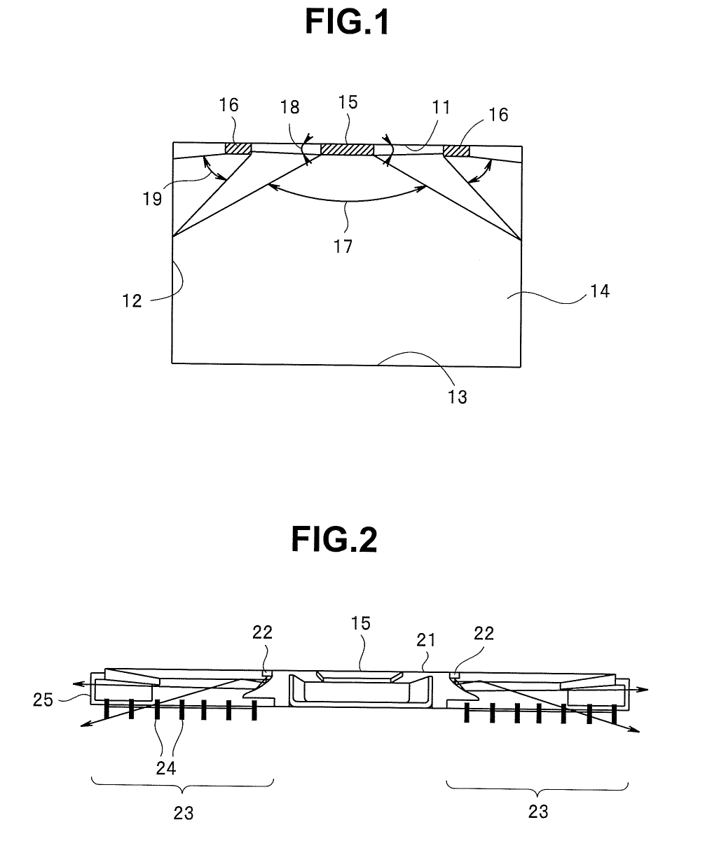

FIG. 1 is a descriptive diagram for describing a method for designing indoor lighting according to an exemplary embodiment.

In the present embodiment, to configure indoor lighting that increases a brightness sensation but suppresses a glare sensation at the same time, two types of luminaire 15 and 16 having different luminous intensity distribution characteristics are employed.

In FIG. 1, a ceiling surface 11, a wall surface 12, and a floor surface 13 form an indoor space 14. The luminaires 15 and 16 are disposed on the ceiling surface 11.

FIG. 2 is a descriptive diagram showing a schematic cross-sectional structure of the first luminaire 15 of the two types of luminaire.

The first luminaire 15 has, for example, a thin box-like or cylindrical shape. An upper surface 21 of the luminaire 15 can be attached to the ceiling surface with an attachment member (not shown). The luminaire 15 is provided with one or more light sources 22, and the luminous intensity distribution of light from each of the light sources 22 is controlled by a light path control portion 23.

The arrows in FIG. 2 indicate the light paths of the light from the light sources 22, and the light path control portion 23 causes part of the light from the light sources 22 to be emitted upward above the horizontal direction through a side surface 25 of the luminaire 15. The luminaire 15 in the present embodiment is so designed that sufficiently high luminous intensities are provided over a range of a luminous intensity distribution angle of the light emitted through the side surface 25 from 90 to 120 degrees with respect to a vertically downward direction, which represents 0 degrees.

Further, the light path control portion 23 is provided with louvres 24 protruding downward, and the louvres 24 block light emitted downward from the luminaire 15 and hence reduces the luminous intensities of the light rays from the luminaire 15 at luminous intensity distribution angles greater than 60 degrees but smaller than 90 degrees. For example, the luminance of the light ray from the luminaire 15 at a luminous intensity distribution angle of 85 degrees is 6874 [cd/cm²].

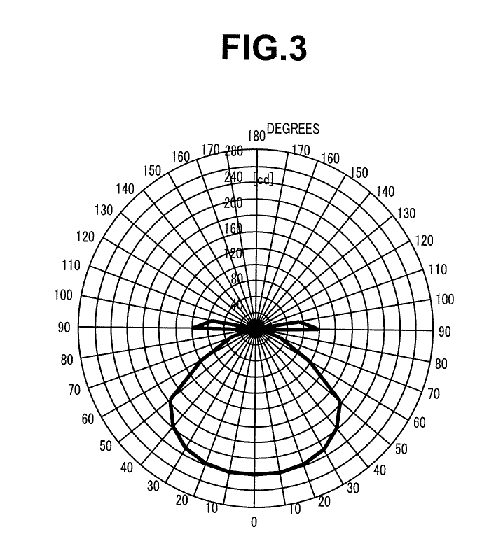

FIG. 3 is a luminous intensity distribution diagram showing the luminous intensity distribution characteristic of the luminaire 15 shown in FIG. 2. In FIG. 3, the circumferential direction represents the luminous intensity distribution angle measured from the vertically downward direction, which represents zero degrees, and the radial direction represents the luminous intensity.

A typical luminaire has, for example, a circular, elliptical, water-droplet-shaped, or a bowl-shaped luminous intensity distribution characteristic and spreads light over a range from 0 to 90 degrees. Further, a luminaire having a heart-shaped or similarly shaped luminous intensity distribution characteristic and not only well spreading light over a range from 0 to 90 degrees but also spreading light over a range from 90 to 120 degrees has also been developed in consideration of lighting toward the ceiling surface.

In contrast, the luminaire 15 shown in FIG. 2 emits light having a luminous intensity distribution in which sufficiently high luminous intensities are provided at 0 to about 60 degrees but sufficiently low luminous intensities at angles greater than about 60 degrees but smaller than 90 degrees, as shown in FIG. 3. That is, the luminaire 15 spreads light downward only within the range from 0 to 60 degrees. The luminaire 15 also has a luminous intensity distribution characteristic so set that the luminous intensity is relatively high over a range from 90 to about 120 degrees.

That is, the luminaire 15 is characterized in that the luminous intensities at angles greater than about 60 degrees but smaller than 90 degrees are sufficiently suppressed but the luminous intensities over the range from 90 to about 120 degrees are sufficiently high.

In the present embodiment, the luminaire 15 is attached to the ceiling surface 11 with the upper surface 21 in contact with the ceiling surface 11, as shown in FIG. 1. Illumination light emitted from the luminaire 15 downward spreads over an arrowed range 17 shown in FIG. 1. The range 17 corresponds to luminous intensity distribution angles ranging from 0 to about 60 degrees, and the indoor space 14 receives sufficiently bright lighting over the range 17.

Further, illumination light emitted through the side surface 25 of the luminaire 15 spreads over an arrowed range 18 shown in FIG. 1. The range 18 corresponds to luminous intensity distribution angles ranging from 90 to about 120 degrees, and the ceiling surface 11 in the indoor space 14 receives sufficiently bright lighting over the range 18.

On the other hand, the second luminaire 16 is formed of a typical luminaire that emits light at luminous intensity distribution angles ranging, for example, from 0 to 90 degrees. In the present embodiment, the luminaire 16 radiates illumination light toward the wall surface 12. Since the first luminaire 15 provides sufficiently suppressed luminous intensities at luminous intensity distribution angles from about 60 to 90 degrees as shown in FIG. 1, the wall surface 12 corresponding to the range is not sufficiently illuminated. In the present embodiment, for example, the second luminaire 16 is disposed on the ceiling surface 11 in a region closer to the wall surface 12 than the first luminaire 15, and the luminous intensity distribution angles of the light emitted from the second luminaire 16 are so defined that the second luminaire 16 illuminates the region of the wall surface 12 where the first luminaire 15 does not sufficiently illuminate. As shown in FIG. 1, the light from the luminaire 16 thus spreads over an arrowed range 19 shown in FIG. 1.

The luminaire 16 only needs to illuminate with illumination light that is not glaring in the eyes of a person the wall surface that is not illuminated by the first luminaire 15, and the luminous intensity distribution angles of the light emitted from the luminaire 16, the position where the luminaire 16 is installed, and other factors of the luminaire 16 can be changed as appropriate. For example, the luminaire 16 may be formed of a luminaire disposed on a wall surface and in the vicinity thereof for indirect lighting.

Since the first luminaire 15 provides sufficiently suppressed luminous intensities at angles greater than about 60 degrees but smaller than 90 degrees, the lighting from the first luminaire 15 is not glaring in the eyes of a person. On the other hand, the lighting from the second luminaire 16 is directed toward the wall surface 12 and is hence not glaring in the eyes of the person.

The first luminaire 15 further illuminates the region of the ceiling surface 11 that corresponds to the angles ranging from 90 to about 120 degrees and contributes to an increase in brightness sensation. On the other hand, the second luminaire 16 illuminates the region of the wall surface 12 that is not sufficiently illuminated by the first luminaire 15, whereby the brightness sensation can be improved as a whole.

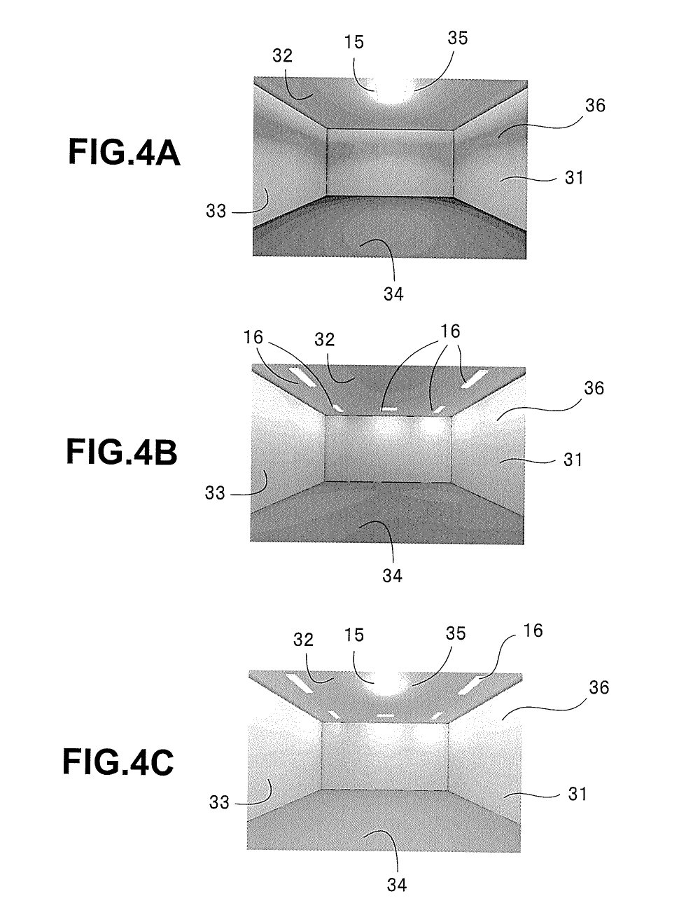

FIGS. 4A to 4C are descriptive diagrams for describing changes in brightness sensation provided when the first and second luminaires 15, 16 are used.

FIGS. 4A to 4C show imaging results obtained when the same space 31 is illuminated under different lighting conditions. Specifically, FIGS. 4A to 4C show the same field of view of images obtained by capturing the same space 31 form the same position. The linear patterns in the figures result from low resolution of the figures, and no such linear patterns are present in the actual captured images. In FIGS. 4A to 4C, the space 31 is surrounded by a ceiling surface 32, a wall surface 33, and a floor surface 34.

FIG. 4A shows a state in which one luminaire 15 attached to the ceiling surface 32 illuminates the space 31. FIG. 4A shows that the luminaire 15 illuminates not only the floor surface 34 but also a region 35, which is part of the ceiling surface 32. On the other hand, a region 36, which is part of the wall surface 33, is relatively dim because the luminaire 15 does not sufficiently illuminate a region corresponding to the luminous intensity distribution angles ranging from about 60 to 90 degrees.

FIG. 4B shows a state in which five luminaires 16 attached to the ceiling surface 32 illuminate the space 31. FIG. 4B shows that the region 36, which is part of the wall surface 33 and is not illuminated sufficiently by the luminaire 15, is brightly illuminated because the luminaires 16 illuminate the region 36.

FIG. 4C shows a state in which one luminaire 15 and five luminaires 16 attached to the ceiling surface 32 illuminate the space 31. The luminaire 15 illuminates the floor surface 34 and the region 35, which is part of the ceiling surface 32, and the luminaires 16 illuminate the region 36, which is part of the wall surface 33. That is, the luminaires 15 and 16 sufficiently illuminate not only the floor surface 34 but also the ceiling surface 32 and the wall surface 33. As described above, using the first and second luminaires 15, 16 allows the ceiling surface 32 and the wall surface 33 to be illuminated to a sufficiently bright level, whereby a sufficient brightness sensation is achieved as a whole.

Further, the light from the luminaire 15 at luminous intensity distribution angles ranging from about 60 to 90 degrees, which is directly incident on the eyes of a person, has sufficiently suppressed luminous intensities and does not cause the person to feel the lighting from the first luminaire 15 glaring. Further, since the lighting from the luminaire 16 is directed toward the wall surface 33, the second luminaire 16 will not cause the person to feel the light therefrom glaring.

Illuminance uniformity on the wall surface 33 on the back side in FIGS. 4A to 4C was determined and found to be 0.25, 0.3, and 0.45, respectively. That is, the illuminance uniformity on the wall surface provided when both the luminaires 15 and 16 are lighted is greater than that provided when only the luminaire 15 or 16 is lighted.

As described above, in the present embodiment, in which the first luminaire, which provides lighting of low luminous intensities at the angles greater than about 60 degrees but smaller than 90 degrees and relatively high luminous intensities at the angles from 90 to about 120 degrees, is disposed on the ceiling and the second luminaire, which illuminates the wall surface that corresponds to the angles greater than about 60 degrees but smaller than 90 degrees and is not illuminated by the first luminaire, is employed, indoor lighting that provides a sufficient brightness sensation and a suppressed glaring sensation is achieved. Further, relatively high illuminance uniformity is achieved on the wall surface.

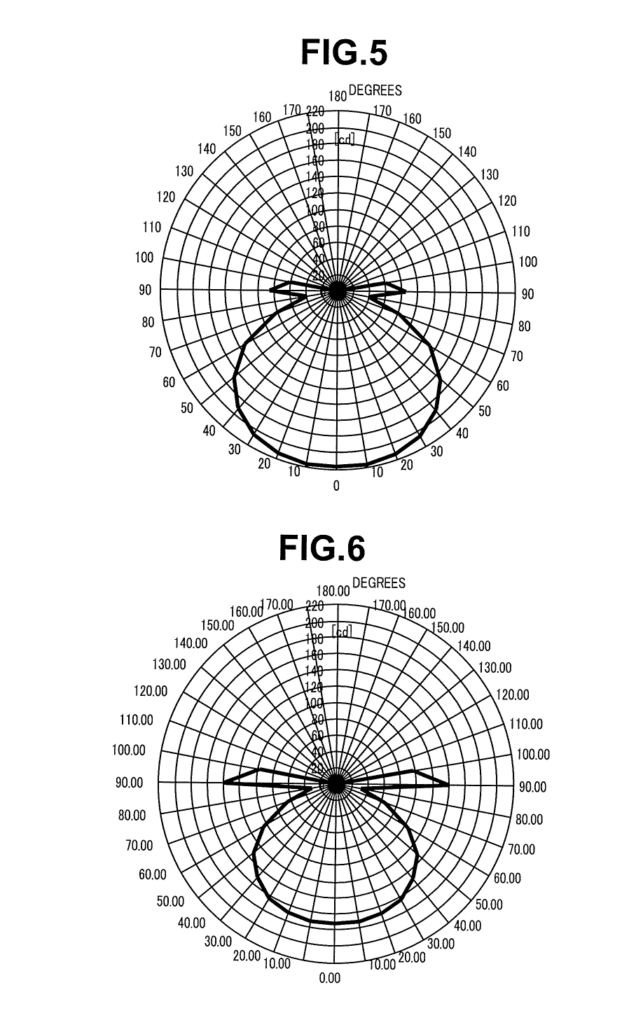

A description will next be made of an optimum luminous intensity distribution characteristic of the first luminaire 15 for suppressing a glaring sensation and achieving a sufficient brightness sensation with reference to FIGS. 5 to 12.

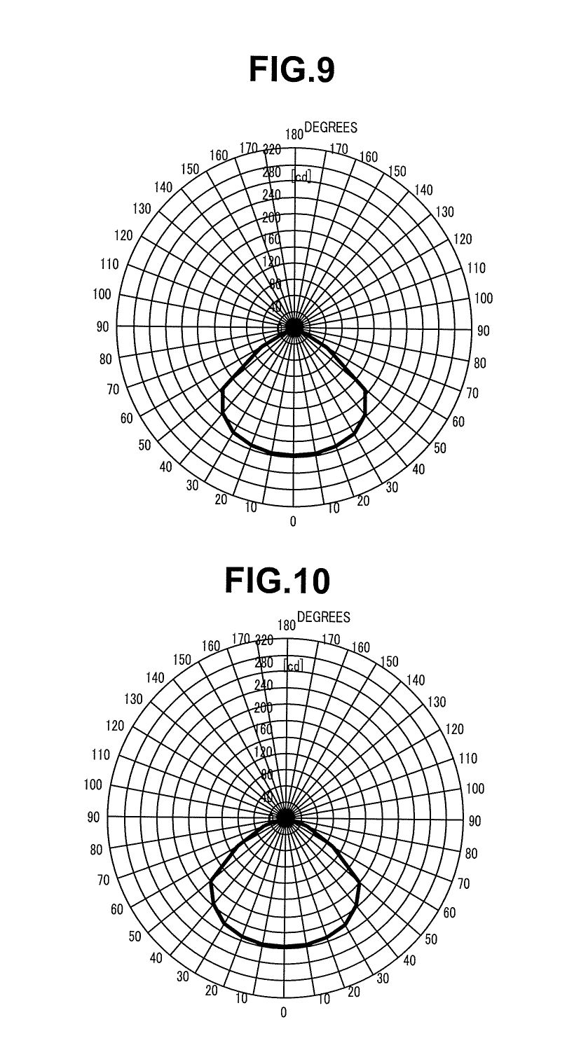

FIGS. 5 to 7 and FIGS. 9 to 11 are luminous intensity distribution diagrams showing luminous intensity distribution characteristics. In each of the figures, the circumferential direction represents the light intensity distribution angle measured from the vertically downward direction, which represents zero degrees, and the radial direction represents the luminous intensity. FIG. 8 shows graphs illustrating the relationship between the brightness sensation and working plane illuminance in a case where luminaires having the luminous intensity distribution characteristics shown in FIGS. 5 to 7 are used to illuminate a predetermined space. FIG. 12 shows graphs illustrating the relationship between the brightness sensation and UGR (unified glare rating) in a case where luminaires having the luminous intensity distribution characteristics shown in FIGS. 9 to 11 are used to illuminate a predetermined space. It is noted that the UGR value increases with the degree of glare perceived by a person.

FIGS. 5 to 7 show examples in which the luminous fluxes of the luminaires over a range between luminous intensity distribution angles of 90 and 120 degrees are about 10%, 20%, and 30% of the entire luminous fluxes of the luminaires, respectively. That is, in FIG. 5, the luminous flux over a range between luminous intensity distribution angles of 0 and 60 degrees accounts for most of the entire luminous flux of the luminaire, and that the luminous flux over the range between luminous intensity distribution angles of 90 and 120 degrees is about 10% of the entire luminous flux of the luminaire. In this case, since the ceiling is only slightly illuminated, it is believed that the space brightness sensation is relatively weak, but that the working plane illuminance is high.

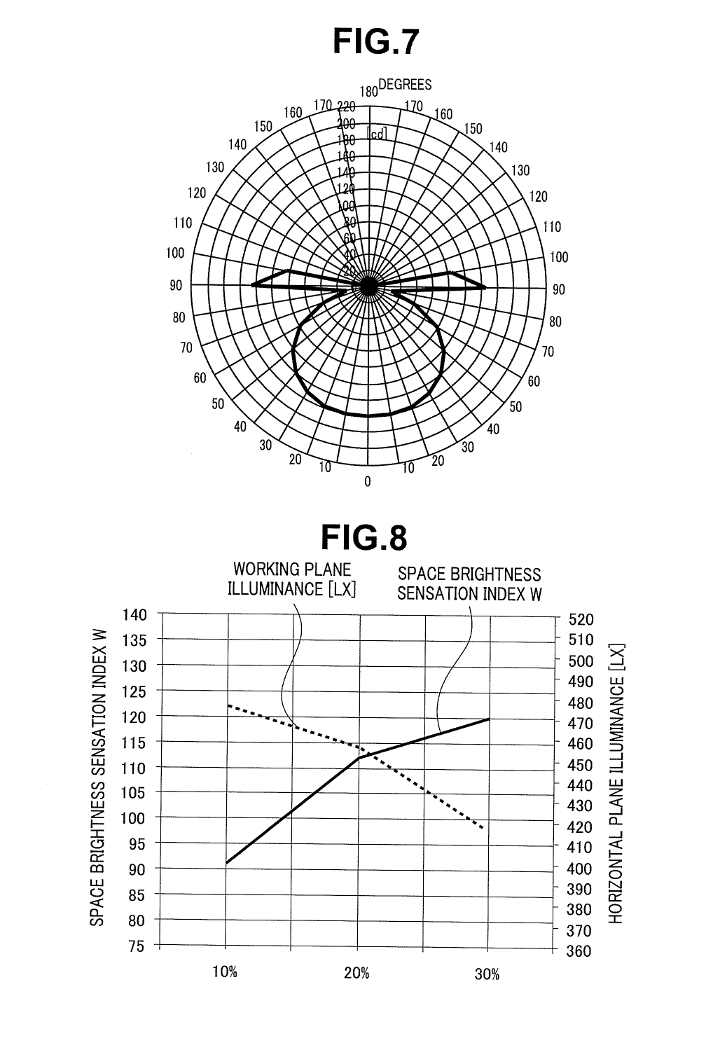

In consideration of the degree of freedom in designing a luminaire, increasing the proportion of the luminous flux over the range between luminous intensity distribution angles of 90 and 120 degrees lowers the proportion of the downward luminous flux. In FIG. 6, the luminous flux over the range between luminous intensity distribution angles of 90 and 120 degrees is about 20% of the entire luminous flux of the luminaire, and in this case, the proportion of the luminous flux over the range between luminous intensity distribution angles of 0 and 60 degrees decreases as compared with the case shown in FIG. 5. Further, in FIG. 7, the luminous flux over the range between luminous intensity distribution angles of 90 and 120 degrees is about 30% of the entire luminous flux of the luminaire, and in this case, the proportion of the luminous flux over the range between luminous intensity distribution angles of 0 and 60 degrees further decreases as compared with the case shown in FIG. 6. That is, it is believed that increasing the proportion of the luminous flux over the range between luminous intensity distribution angles of 90 and 120 degrees improves the space brightness sensation but lowers the working plane illuminance.

FIG. 8 shows the improvement in the brightness sensation versus the decreases in the working plane illuminance. The solid line represents a space brightness sensation index W in a case where the luminaires having the luminous intensity distribution characteristics shown in FIGS. 5 to 7 illuminate an indoor space, and the broken line represents the working plane illuminance in the case where the luminaires having the luminous intensity distribution characteristics shown in FIGS. 5 to 7 illuminate the indoor space.

As shown in FIG. 8, the amount of increase in the space brightness sensation index W when the proportion of the luminous flux over the range between luminous intensity distribution angles of 90 and 120 degrees with respect to the entire luminous flux of the luminaire changes from 20% to 30% is smaller than the amount of increase in the space brightness sensation index W when the proportion of the luminous flux over the range between luminous intensity distribution angles of 90 and 120 degrees changes from 10% to 20%. Further, the amount of decrease in the working plane illuminance when the proportion of the luminous flux over the range between luminous intensity distribution angles of 90 and 120 degrees with respect to the entire luminous flux of the luminaire changes from 10% to 20% is smaller than the amount of decrease in the working plane illuminance when the proportion of the luminous flux over the range between luminous intensity distribution angles of 90 and 120 degrees changes from 20% to 30%.

The facts described above therefore indicate that a luminaire so configured that the luminous flux over the range between luminous intensity distribution angles of 90 and 120 degrees is about 20% of the entire luminous flux of the luminaire can provide a sufficient space brightness sensation while providing sufficient working plane illuminance in an efficient manner. To increase the space brightness sensation, a luminaire maybe so designed that the luminous flux over the range between luminous intensity distribution angles of 90 and 120 degrees with respect to the entire luminous flux of the luminaire is 20% or higher, preferably about 20%.

FIGS. 9 to 11 show examples in which the luminous fluxes of the luminaires over a range of luminous intensity distribution angles greater than 60 degrees but smaller than 90 degrees are about 10%, 20%, and 30% of the entire luminous fluxes of the luminaires, respectively. That is, FIG. 9 shows an example in which the luminous flux over the range of luminous intensity distribution angles greater than 60 degrees but smaller than 90 degrees is about 10% of the entire luminous flux of the luminaire. In this case, since the wall surface is not sufficiently illuminated, it is believed that the space brightness sensation is relatively weak, but that the degree of glare perceived by a person is low.

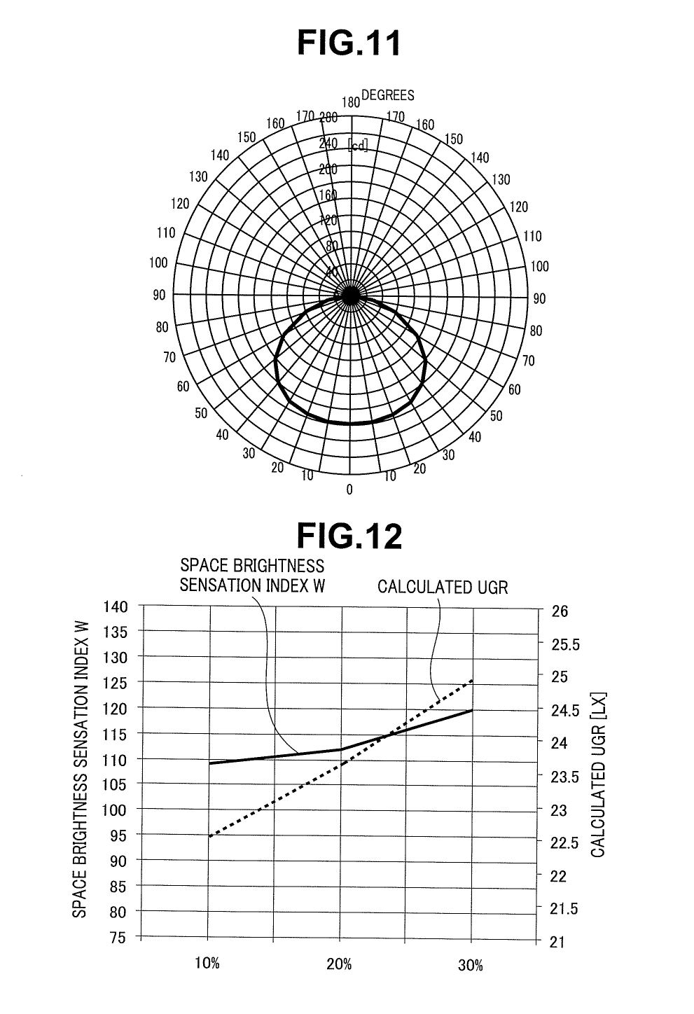

In FIG. 10, the luminous flux over the range between luminous intensity distribution angles of 60 and 90 degrees is about 20% of the entire luminous flux of the luminaire. In this case, the space brightness sensation increases as compared with the case shown in FIG. 9, but the degree of glare perceived by the person also increases. Further, in FIG. 11, the luminous flux over the range between luminous intensity distribution angles of 60 and 90 degrees is about 30% of the entire luminous flux of the luminaire. In this case, the space brightness sensation increases as compared with the case shown in FIG. 10, but the degree of glare perceived by the person also further increases. That is, it is believed that increasing the proportion of the luminous flux over the range of luminous intensity distribution angles greater than 60 degrees but smaller than 90 degrees improves the space brightness sensation whereas also increasing the degree of glare perceived by the person.

FIG. 12 shows the improvement in the brightness sensation versus the increase in the degree of glare perceived by the person. The solid line represents the space brightness sensation index W in a case where the luminaires having the luminous intensity distribution characteristics shown in FIGS. 9 to 11 illuminate an indoor space, and the broken line represents the UGR value in the case where the luminaires having the luminous intensity distribution characteristics shown in FIGS. 9 to 11 illuminate the indoor space.

As shown in FIG. 12, the amount of increase in the space brightness sensation index W when the proportion of the luminous flux over the range between luminous intensity distribution angles of 60 and 90 degrees with respect to the entire luminous flux of the luminaire changes from 20% to 30% is greater than the amount of increase in the space brightness sensation index W when the proportion of the luminous flux over the range between luminous intensity distribution angles of 60 and 90 degrees changes from 10% to 20%. On the other hand, the UGR value increases substantially in proportion to the increase in the proportion of the luminous flux over the range between luminous intensity distribution angles of 60 and 90 degrees with respect to the entire luminous flux of the luminaire.

To sufficiently lower the glare sensation, the luminous flux of a luminaire over the range of luminous intensity distribution angles greater than 60 degrees but smaller than 90 degrees is therefore preferably set to 20% of the entire luminous flux of the luminaire or lower. FIG. 12 shows that using a luminaire so configured that the luminous flux over the range of luminous intensity distribution angles greater than 60 degrees but smaller than 90 degrees is about 20% of the entire luminous flux from the luminaire can provide a sufficient space brightness sensation while lowering the glaring sensation in an efficient manner.

The above embodiment has been described with reference to the case where the first luminaire has a box-like or cylindrical shape, but the shape, the size, the number in a space, and other factors of each of the first and second luminaires are not limited to specific values but can be changed as appropriate.

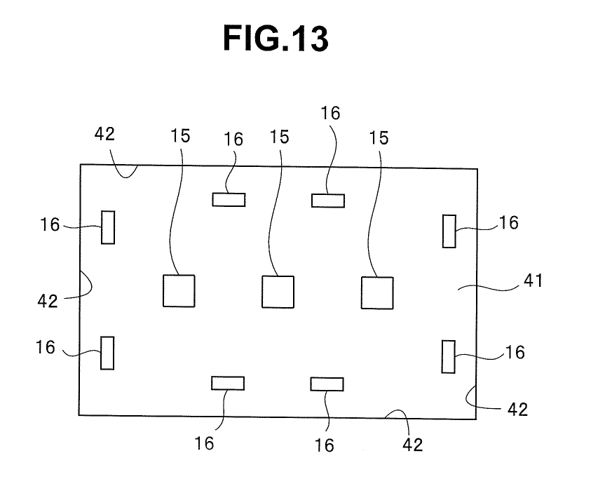

Further, the above embodiment has been described with reference to the case where one first luminaire is provided on a ceiling surface, but a plurality of first luminaires may be used. FIG. 13 is a descriptive diagram showing a case where a plurality of first luminaires and a plurality of second luminaires are used.

In FIG. 13, three first luminaires 15 are disposed straight in a substantially central portion of a ceiling surface 41, and eight second luminaires 16 are disposed between the luminaires 15 but away therefrom toward a wall surface 42. Since the luminaires 16 are disposed between the luminaires 15, the illuminance uniformity on the well surface 42 can be improved in the example shown in FIG. 13.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the systems described herein may be made without departing from the spirit of the inventions. The accompanying claims and their equivalents are intended to cover such forms or modifications as would fall within the scope and spirit of the inventions.

What is claimed is:

1. A method for designing indoor lighting, the method comprising:
disposing a first luminaire on a ceiling surface that forms an indoor space, the first luminaire having a luminous intensity distribution characteristic so set that a luminous flux over a range of luminous intensity distribution angles greater than or equal to 90 degrees but smaller than or equal to 120 degrees with respect to a vertically downward direction, which represents 0 degrees, is 20% of a luminous flux of the luminaire or greater and a luminous flux over a range of luminous intensity distribution angles greater than or equal to 60 degrees but smaller than 90 degrees is 20% of the luminous flux of the luminaire or smaller; and
disposing a second luminaire in the indoor space, the second luminaire illuminating a wall surface present in a region corresponding to the luminous intensity distribution angles of light from the first luminaire greater than or equal to 60 degrees but smaller than 90 degrees.

2. The method according to claim 1,
wherein the second luminaire is disposed on the ceiling surface in a region between the first luminaire and the wall surface present in the region corresponding to the luminous intensity distribution angles of light from the first luminaire greater than or equal to 60 degrees but smaller than 90 degrees.

3. The method according to claim 1,
wherein the first luminaire is configured to have a luminous intensity distribution characteristic so set that at least 80% of a luminous flux over a range of luminous intensity distribution angles greater than or equal to 60 degrees but smaller than or equal to 180 degrees is within a range or luminous intensity distribution angles of greater than or equal to 90 degrees but smaller than 110 degrees.

4. The method according to claim 1,
wherein the first and second luminaires are so disposed that illuminance uniformity on a wall surface illuminated by the first and second luminaires is greater than the illuminance uniformity on the wall surface illuminated by one of the first and second luminaires.

5. The method according to claim 1,
wherein the first luminaire is disposed at a plurality of locations in a central portion of the ceiling surface, and
the second luminaire is disposed at a plurality of locations on the ceiling surface in a region closer to the wall than the first luminaires.

6. The method according to claim 2,
wherein the first luminaire is configured to have a luminous intensity distribution characteristic so set that at least 80% of a luminous flux over a range of luminous intensity distribution angles greater than or equal to 60 degrees but smaller than or equal to 180 degrees is within a range of luminous intensity distribution angles of greater than or equal to 90 degrees but smaller than 110 degrees.

7. The method according to claim 2,
wherein the first and second luminaires are so disposed that illuminance uniformity on a wall surface illuminated by the first and second luminaires is greater than the illuminance uniformity on the wall surface illuminated by one of the first and second luminaires.

8. The method according to claim 2,
wherein the first luminaire is disposed at a plurality of locations in a central portion of the ceiling surface, and
the second luminaire is disposed at a plurality of locations on the ceiling surface in a region closer to the wall than the first luminaires.

9. The method according to claim 3,
wherein the first and second luminaires are so disposed that illuminance uniformity on a wall surface illuminated by the first and second luminaires is greater than the illuminance uniformity on the wall surface illuminated by one of the first and second luminaires.

10. The method according to claim 3,
wherein the first luminaire is disposed at a plurality of locations in a central portion of the ceiling surface, and
the second luminaire is disposed at a plurality of locations on the ceiling surface in a region closer to the wall than the first luminaires.

11. The method according to claim 6,
wherein the first and second luminaires are so disposed that illuminance uniformity on a wall surface illuminated by the first and second luminaires is greater than the illuminance uniformity on the wall surface illuminated by one of the first and second luminaires.

12. The method according to claim 6,
wherein the first luminaire is disposed at a plurality of locations in a central portion of the ceiling surface, and
the second luminaire is disposed at a plurality of locations on the ceiling surface in a region closer to the wall than the first luminaires.
